(19) United States
(12) Patent Application Publication
(10) Pub. No.: US 2019/0155415 A1
(43) Pub. Date: May 23, 2019

(54) INPUT DEVICE

(71) Applicant: Yazaki Corporation, Tokyo (JP)

(72) Inventors: Hisataka KATO, Shizuoka (JP); Yasunori KAWAGUCHI, Shizuoka (JP)

(73) Assignee: Yazaki Corporation, Tokyo (JP)

(21) Appl. No.: 16/182,912

(22) Filed: Nov. 7, 2018

(30) Foreign Application Priority Data
Nov. 22, 2017 (JP) 2017-224320

(51) Int. Cl. G06F 3/044; G06F 3/041

(52) U.S. Cl. CPC G06F 3/044; B60K 37/06; G06F 3/0416

(57) ABSTRACT

An input device includes an electrostatic sensor having a plurality of detection units, and an operation body having a contact operation surface. The contact operation surface is an assembly of a plurality of contact points that all the contact points are arranged with a distance from the detection surface in a direction perpendicular to the detection surface, and the contact operation surface is divided into at least two regions where the distance between the detection surface and the contact point becomes nonuniform. The detection unit includes one first electrode unit and one second electrode unit. In the electrostatic sensor, an overlapping area of the first electrode unit and the second electrode unit decreases as the detection unit is disposed in such a way that a distance with the contact point on the detection surface becomes narrower.

### CROSS-REFERENCE TO RELATED APPLICATION(S)

The present application claims priority to and incorporates by reference the entire contents of Japanese Patent Application No. 2017-224320 filed in Japan on Nov. 22, 2017.

### BACKGROUND OF THE INVENTION

### 1. Field of the Invention

The present invention relates to an input device.

### 2. Description of the Related Art

Conventionally, for example, an input device for operating various in-vehicle devices is mounted on a vehicle. As such an input device, there is known an input device for which a contact operation by an operator on a contact operation surface is set as an input operation type, and an electrostatic capacitance is varied in response to the contact operation. This type of input device includes an operation body having a contact operation surface and an electrostatic sensor for detecting a contact position of the operator's finger on the contact operation surface (Japanese Patent Application Laid-open No. 2017-91219). In the electrostatic sensor, a plurality of detection units are scattered on a two-dimensional plane serving as a detection surface, and the electrostatic capacitance is measured by each detection unit. A control device receives information on the electrostatic capacitance of each detection unit from the input device, and detects the contact position of the finger on the contact operation surface based on position information of the detection unit in which a variation in the electrostatic capacitance has been measured.

Incidentally, the contact operation surface is not necessarily a plane parallel to the detection surface of the electrostatic sensor, and may be formed to be nonplanar according to various requirements such as operability and design reasons. Further, even if the contact operation surface forms a plane, the contact operation surface may be inclined with respect to the detection surface of the electrostatic sensor in some cases. In these cases, in the input device, a distance between the contact position of the finger on the contact operation surface and the detection surface of the electrostatic sensor is not uniform in all the contact positions in a direction perpendicular to the detection surface. Therefore, there is a possibility that this input device causes a variation in detection sensitivity for each contact position on the contact operation surface. In the input device described in JP 2017-91219 A, a detection body has a nonplanar contact operation surface and, in order to suppress the variation in the detection sensitivity, a sensitivity adjustment layer, which has a higher dielectric constant as a distance between the contact position and the detection surface is longer, is provided between the detection object and the electrostatic sensor. However, since the number of components of the input device increases by an amount of the sensitivity adjustment layer, there is room for improvement from the viewpoint of downsizing a physique and reducing a cost.

### SUMMARY OF THE INVENTION

It is therefore an object of the present invention to provide an input device capable of suppressing the variation in detection sensitivity without increasing the number of components.

An input device according to one aspect of the present invention includes an electrostatic sensor having a plurality of detection units arranged on a two-dimensional plane serving as a detection surface of an operation mode; and an operation body having a contact operation surface to be contact-operated by an operator, wherein the contact operation surface is an assembly of a plurality of contact points that the operator can touch with his finger, all the contact points are arranged with a distance from the detection surface in a direction perpendicular to the detection surface, and the contact operation surface is divided into at least two regions where the distance between the detection surface and the contact point becomes nonuniform, the detection unit includes one first electrode unit and one second electrode unit, the first and second electrode units being arranged in the direction perpendicular to the detection surface so as to have an inter-electrode distance therebetween to generate an electrostatic capacitance, and the first electrode unit and the second electrode unit varying the electrostatic capacitance in accordance with the contact operation by the operator on the contact operation surface or when the operator brings his finger close to the contact operation surface, and in the electrostatic sensor, an overlapping area of the first electrode unit and the second electrode unit when viewed in the direction perpendicular to the detection surface decreases as the detection unit is disposed in such a way that a distance with the contact point on the detection surface becomes narrower in the direction perpendicular to the detection surface.

According to another aspect of the present invention, in the input device, it is preferable that the electrostatic sensor includes a first electrode group and a second electrode group, the first electrode group having a plurality of first electrodes extending in the same direction along a first parallel plane with respect to the detection surface, the plurality of first electrodes being disposed in parallel while having a space therebetween in a direction perpendicular to an extending direction of the first electrodes, the second electrode group having a plurality of second electrodes extending in the same direction along a second parallel plane with respect to the detection surface, and the plurality of second electrodes being disposed in parallel while having a space therebetween in a direction perpendicular to an extending direction of the second electrodes, the first electrode group and the second electrode group are disposed in the direction perpendicular to the detection surface while having the inter-electrode distance therebetween and in such a way that the first electrode and the second electrode intersect with each other when viewed in the direction perpendicular to the detection surface, each of the first electrodes includes the first electrode unit intersecting with the second electrode unit in the direction perpendicular to the detection surface for each of the second electrodes, and each of the second electrodes includes the second electrode unit intersecting with the first electrode unit in the direction perpendicular to the detection surface for each of the first electrodes.

According to still another aspect of the present invention, in the input device, it is preferable that the contact operation surface is formed to be a nonplanar surface.

According to still another aspect of the present invention, in the input device, it is preferable that, when the contact operation surface is a spherical curved surface, the overlapping area decreases as the detection unit is disposed at a position more distant from a center on the detection surface.

According to still another aspect of the present invention, in the input device, it is preferable that, when an arcuate curved surface along one direction is formed as the contact operation surface, the overlapping area decreases as the detection unit is disposed closer to an end portion of a curved line forming the curved surface than a middle portion of the curved line.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an input device according to an embodiment;

FIG. 2 is an explanatory diagram illustrating a layered structure of an input device according to an embodiment;

FIG. 3 is an explanatory view of an example of a configuration of an electrostatic sensor as seen from a detection surface;

FIG. 4 is an explanatory diagram schematically illustrating a configuration of a detection unit in an electrostatic sensor;

FIG. 5 is an explanatory view of a modification of a configuration of an electrostatic sensor as seen from a detection surface;

FIG. 6 is an explanatory view of a modification of a configuration of an electrostatic sensor as seen from a detection surface;

FIG. 7 is an explanatory view of a modification of a configuration of an electrostatic sensor as seen from a detection surface;

FIG. 8 is a perspective view illustrating an input device according to a modification;

FIG. 9 is an explanatory view illustrating a layered structure of an input device of a modification;

FIG. 10 is an explanatory view of an example of a configuration of an electrostatic sensor according to a modification as seen from a detection surface; and

FIG. 11 is an explanatory diagram schematically illustrating a configuration of a detection unit in an electrostatic sensor of a modification.

### DETAILED DESCRIPTION OF THE PREFERRED EMBODIMENTS

Hereinafter, embodiments of an input device according to the present invention will be described in detail with reference to the drawings. It should be noted that the present invention is not limited by the embodiments.

### Embodiment

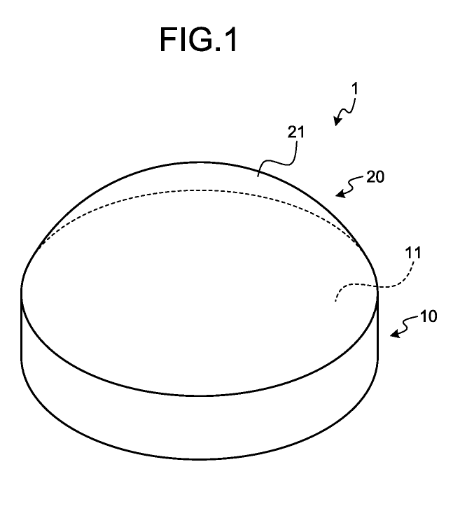

One embodiment of the input device according to the present invention will be described with reference to FIGS. 1 to 11.

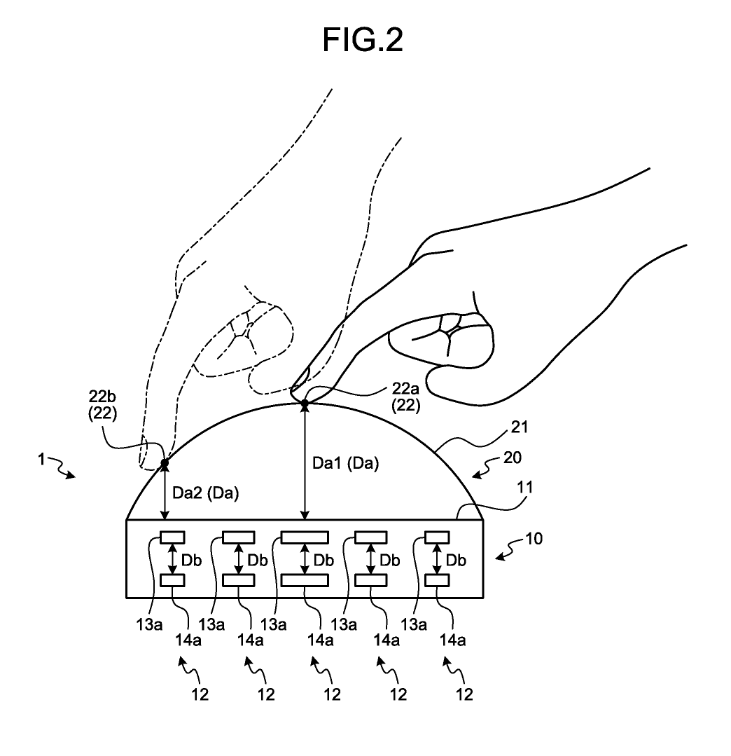

Reference numeral 1 in FIGS. 1 and 2 indicates an input device according to the present embodiment. The input device 1 has an input operation type of a contact operation with a finger of an operator on a contact operation surface or a movement (operation) of the finger at a position distant from the contact operation surface within a predetermined range, and outputs a signal according to the operation to a control device (not illustrated). For example, by mounting the control device on the vehicle together with the input device 1, the control device operates or stops an in-vehicle device (not illustrated) mounted in the vehicle. In this case, although not illustrated, the input device 1 is provided at, for example, a center console, an instrument panel, a tip of a lever switch extending from a steering column in a direction of a vehicle width, and the like, which are positions where an operator (such as a driver of a vehicle) can operate in a vehicle cabin of the vehicle.

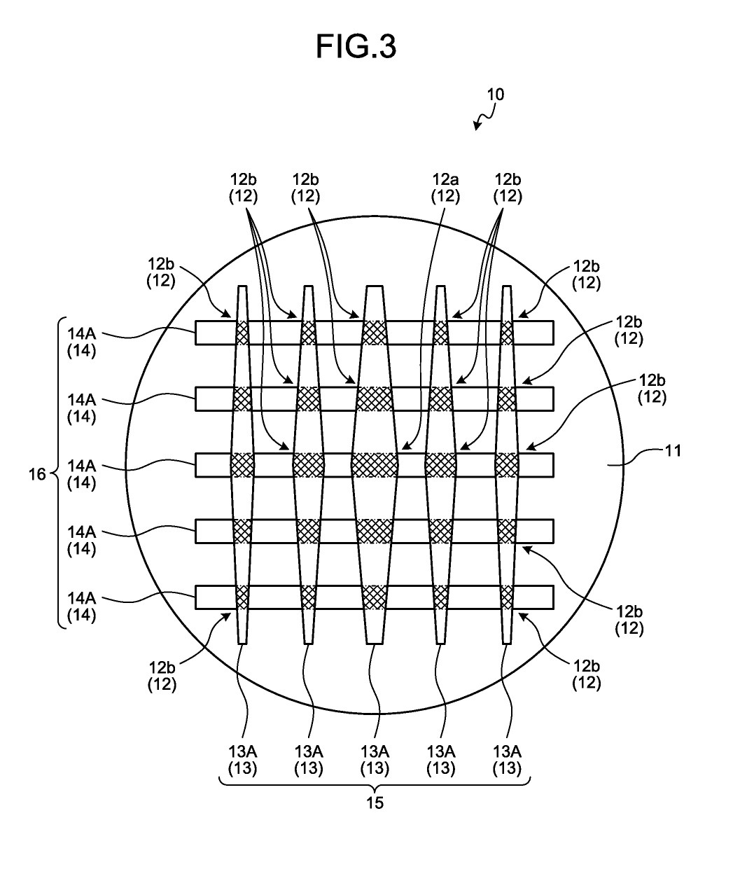

The input device 1 of the present embodiment adopts an electrostatic capacitance method of varying an electrostatic capacitance of each detection point according to an operation mode of the operator. Therefore, the input device 1 includes an electrostatic sensor 10 and an operation body 20 (FIGS. 1 and 2). In the input device 1, the electrostatic sensor 10 and the operation body 20 are layered. The electrostatic sensor 10 has a plurality of detection units 12 arranged on a two-dimensional plane serving as a detection surface 11 of the operation mode (cross-hatched portions in FIG. 3). The electrostatic sensor 10 includes, for example, a printed substrate (PCB: Printed Circuit Board) on which electronic components and the like are mounted, a conductive film on which a conductor is printed or the like on a base film, or a conductive paste in which a conductor is dispersed in a synthetic resin, or the like. The operation body 20 has a contact operation surface 21 which is contact-operated by the operator (FIGS. 1 and 2). As the operation body 20, a dielectric such as a glass or a synthetic resin is used. A specific example of the input device 1 will be described below.

The contact operation surface 21 is an assembly of a plurality of contact points 22 (FIG. 2) which the operator can touch with his finger. All the contact points 22 of the contact operation surface 21 are arranged with a distance Da from the detection surface 11 of the electrostatic sensor 10 in a direction perpendicular to the detection surface 11.

The contact operation surface 21 is divided into at least two regions where the distance Da between the detection surface 11 and the contact point 22 becomes non-uniform. More specifically, the contact operation surface 21 is a nonplanar surface, or if it is a plane, the contact operation surface 21 is inclined with respect to the detection surface 11. In this example, the contact operation surface 21 is formed so as to form a spherical curved surface (FIG. 1). Therefore, in the input device 1, a distance Da1 between a contact point 22a at a middle portion (center) of a curved line forming the curved surface and the detection surface 11 is the widest on the curve, and a distance Da2 between a contact point 22b and the detection surface 11 decreases as going from the middle portion to an end portion of the curved line (FIG. 2).

Here, on the contact operation surface 21, a slide operation of tracing the contact operation surface 21 with a fingertip, a flick operation of sweeping the contact operation surface 21 in a certain direction with the fingertip, and a touch operation of contacting the contact operation surface 21 with the fingertip are assigned as contact operation modes.

On the contact operation surface 21, a plurality of contact points among all the contact points 22 are covered with the operator's finger. The electrostatic sensor 10 can output a distribution of the plurality of contact points 22 covered with the finger on the contact operation surface 21 to the control device as variation information of the electrostatic capacitance of each detection unit 12. Therefore, the control device can detect what place on the contact operation surface 21 the operator is contacting. Further, the control device can grasp a contact center point by the finger with respect to the contact operation surface 21 based on the distribution of the plurality of contact points 22 covered with the finger. For example, if the contact center point does not change by a predetermined distance or more, the control device detects it as the touch operation, and if the contact center point has changed by a predetermined distance or more, the control device detects it as the slide operation or the flick operation.

The detection surface 11 of the electrostatic sensor 10 is formed in a circular shape, since the contact operation surface 21 is formed in a spherical curved surface.

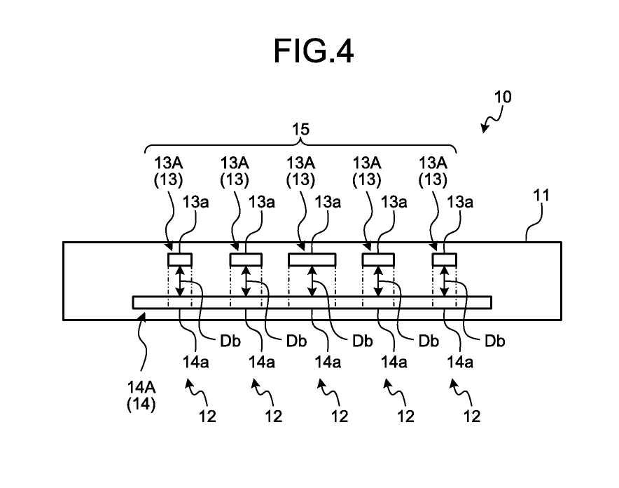

The detection unit 12 of the electrostatic sensor 10 has one first electrode unit 13a and one second electrode unit 14a (FIG. 4). The first electrode unit 13a and the second electrode unit 14a are arranged in a direction perpendicular to the detection surface 11 so as to have an inter-electrode distance Db therebetween to generate an electrostatic capacitance. In addition, the first electrode unit 13a and the second electrode unit 14a vary the electrostatic capacitance in accordance with the contact operation by the operator on the contact operation surface 21 or when the operator brings his finger close to the contact operation surface 21. Here, the first electrode unit 13a is arranged closer to the contact operation surface 21 than the second electrode unit 14a, and the first electrode unit 13a functions as a transmission electrode and the second electrode unit 14a functions as a reception electrode.

In the electrostatic sensor 10, an overlapping area (cross-hatched portions in FIG. 3) of the first electrode unit 13a and the second electrode unit 14a when viewed in the direction perpendicular to the detection surface 11 decreases, as the detection unit 12 is disposed in such a way that the distance Da between the contact point 22 and the detection surface 11 becomes narrower. That is, the electrostatic capacitance of the detection unit 12 decreases, as the distance Da from the contact point 22 on the detection surface 11 is narrower. In this example, since the contact operation surface 21 is formed as a spherical curved surface, the overlapping area is set to be smaller, as the detection unit 12 is disposed at a position more distant from the center on the detection surface 11. Thus, in the electrostatic sensor 10, the detection sensitivities of the detection units 12 can be brought close to each other. In other words, in the input device 1, variation in detection sensitivity is suppressed between the detection unit 12a disposed at the position where the distance Da1 from the contact point 22a on the detection surface 11 is the widest and the detection units 12 (the detection unit 12b) other than the detection unit 12a. Therefore, in the input device 1, variations in the detection sensitivity due to the contact operation at the respective positions of the contact operation surface 21 (that is, the respective contact points 22) can be reduced. In addition, even when the operator moves his finger at a position distant from the contact operation surface 21 within a predetermined range, the input device 1 can reduce the variation in detection sensitivity.

As described above, the input device 1 of the present embodiment can adjust the detection sensitivity of each detection unit 12. Therefore, in each detection unit 12, the overlapping area is adjusted so that the respective detection sensitivities become equal.

In this example, specifically, the overlapping area of each detection unit 12 is adjusted in the following manner.

The electrostatic sensor 10 includes a first electrode group 15 in which a plurality of first electrodes 13 having a plurality of first electrode units 13a are arranged, and a second electrode group 16 in which a plurality of second electrodes 14 having a plurality of second electrode units 14a are arranged (FIG. 3). In the electrostatic sensor 10, the first electrode group 15 is arranged closer to the contact operation surface 21 than the second electrode group 16 is. Further, in the electrostatic sensor 10, the first electrode 13 is used as a transmission electrode and the second electrode 14 is used as a reception electrode.

In this example, the first electrode group 15 has a plurality of first electrodes 13A extending in the same direction along a first parallel plane with respect to the detection surface 11 as the first electrode 13 (FIG. 3). In the first electrode group 15, the plurality of first electrodes 13A are disposed in parallel while having a space therebetween in a direction perpendicular to the extending direction of the first electrodes 13A. In addition, the second electrode group 16 has a plurality of second electrodes 14A extending in the same direction along a second parallel plane with respect to the detection surface 11 as the second electrode 14 (FIG. 3). In the second electrode group 16, the plurality of second electrodes 14A are disposed in parallel with a space therebetween in a direction perpendicular to the extending direction of the second electrodes 14A.

In the electrostatic sensor 10, the first electrode group 15 and the second electrode group 16 are disposed in a direction perpendicular to the detection surface 11 while having an inter-electrode distance Db therebetween. Further, the first electrode group 15 and the second electrode group 16 are disposed in such a way that the first electrode 13 and the second electrode 14 intersect with each other when viewed in a direction perpendicular to the detection surface 11. Here, each of the first electrodes 13A is perpendicular to all the second electrodes 14A. That is, in the electrostatic sensor 10, all the first electrodes 13A and all the second electrodes 14 A are arranged so as to form a net shape as viewed in the direction perpendicular to the detection surface 11. Therefore, the first electrode 13A has the first electrode unit 13a intersecting with the second electrode unit 14a in the direction perpendicular to the detection surface 11 for each second electrode 14A. Further, the second electrode 14A has the second electrode unit 14a intersecting with the first electrode unit 13a in the direction perpendicular to the detection surface 11 for each first electrode 13A.

In this example, the contact operation surface 21 is formed in a spherical curved surface. Therefore, as described above, the overlapping area decreases as the detection unit 12 is disposed at a position more distant from the center on the detection surface 11.

For example, in order to obtain a difference in a size of the overlapping area for each detection unit 12, all the first electrodes 13A are formed so that widths of the first electrodes 13A along the first parallel plane become narrower from a center toward respective end portions in an extending direction of the first electrodes 13A (FIG. 3). For example, the first electrode 13A is formed in a polygonal shape having five or more sides or a rhombus shape. Here, the first electrode 13A is formed into a hexagon (a shape which can be said to be a pseudo-rhombus). Each of the first electrodes 13A is formed to have a narrower width of the first electrode unit 13a, as it is disposed at a position more distant from the center on the detection surface 11 for each of the second electrode 14A to be commonly intersected with all the first electrodes 13A (FIG. 3). Due to shape adjustment of the first electrode 13A of the first electrode group 15, the overlapping area of the detection unit 12 becomes smaller as the detection unit 12 is disposed at a position more distant from the center on the detection surface 11.

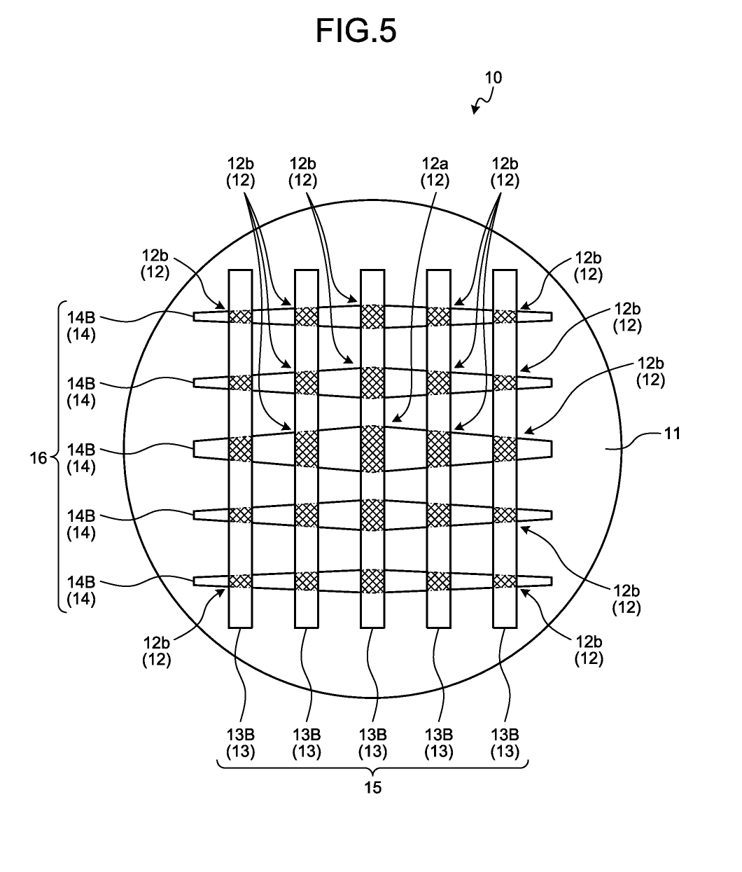

Further, instead of this, the shape of the second electrode 14 of the second electrode group 16 in the electrostatic sensor 10 is adjusted like the second electrode 14B illustrated in FIG. 5, so that the difference in the size of the overlapping area of each detection unit 12 may be obtained. In this case, all the second electrodes 14B are formed such that widths of the second electrodes 14B along the second parallel plane become narrower from a center toward respective end portions in an extending direction of the second electrodes 14B. The second electrode 14B is formed to have a polygonal shape of five or more sides or a rhombus shape like the first electrode 13A described above. Here, the second electrode 14B is formed into a hexagon (a shape which can be said to be a pseudo-rhombus). Each of the second electrodes 14B is formed to have a narrower width of the second electrode unit 14a, as it is disposed at a position more distant from the center on the detection surface 11 for each of the first electrode 13B to be commonly intersected with all the second electrodes 14B (FIG. 5). As a result, the overlapping area of the detection unit 12 decreases as the detection unit 12 is disposed at a position more distant from the center on the detection surface 11.

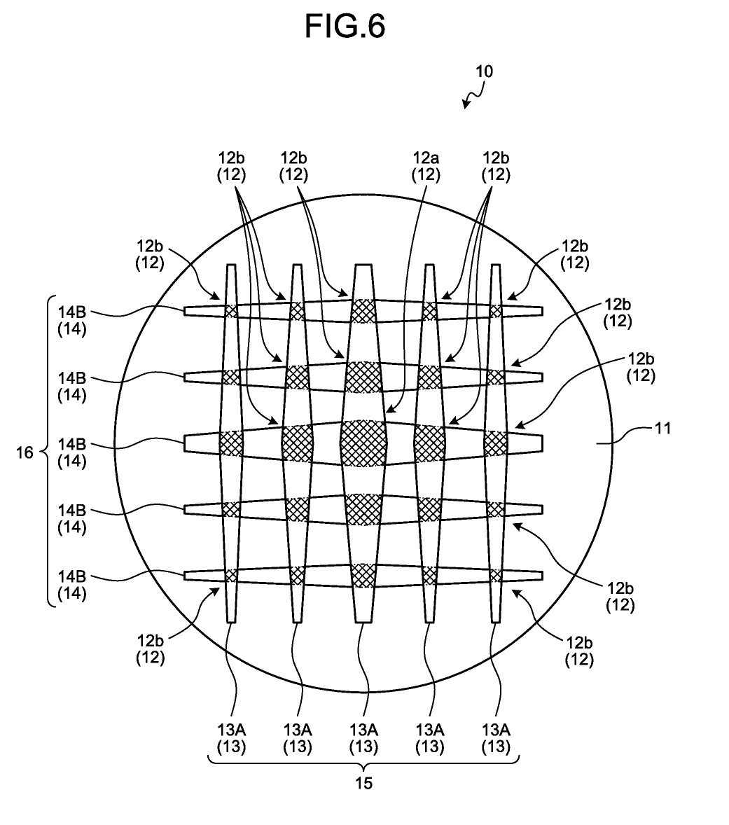

Further, in the electrostatic sensor 10, the shapes of the first electrodes 13A of the first electrode group 15 and the shapes of the second electrodes 14B of the second electrode group 16 may be adjusted together (FIG. 6). As a result, the electrostatic sensor 10 performs a comparison with one of the first electrode group 15 and the second electrode group 16 adjusted in shape, thereby suppressing the variation in the size of the overlapping area of each detection unit 12 in a circumferential direction of the detection surface 11. Therefore, the electrostatic sensor 10 can reduce variations in detection sensitivity in the circumferential direction of the detection surface 11.

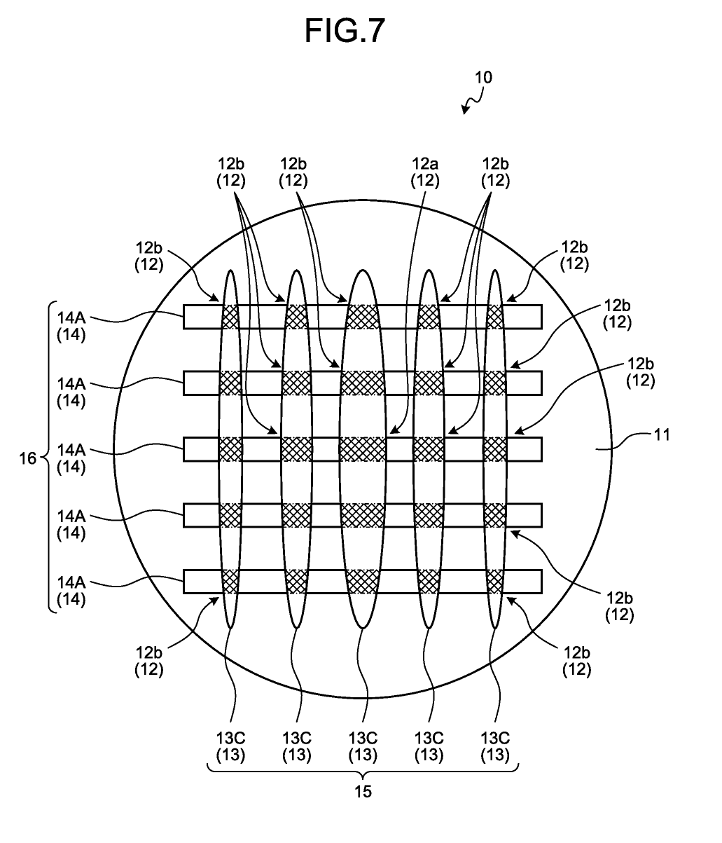

Still further, in the electrostatic sensor 10, at least one of the first electrode 13 of the first electrode group 15 and the second electrode 14 of the second electrode group 16 may be formed in an elliptical shape. Here, an example in which the first electrode 13C of the first electrode group 15 is formed in an elliptical shape is illustrated (FIG. 7). Each of the first electrodes 13C is formed to have a narrower width of the first electrode unit 13a, as it is disposed at a position more distant from the center on the detection surface 11 for each of the second electrodes 14A to be crossed which is commonly intersected with all the first electrodes 13C (FIG. 7). As the elliptical first electrode 13C is disposed at a position more distant from the center on the detection surface 11, curvatures of the two sides which are opposed to each other and extend in an extending direction of the first electrodes 13C increase, decreasing widths of the first electrodes 13C. Further, in this electrostatic sensor 10, the overlapping area of the detection unit 12 becomes smaller as the detection unit 12 is disposed at a position more distant from the center on the detection surface 11.

As described above, in the input device 1 of the present embodiment, the overlapping area of the first electrode unit 13a and the second electrode unit 14a constituting the detection unit 12 is adjusted according to the distance Da between the detection unit 12 on the detection surface 11 and the contact point 22 in the direction perpendicular to the detection surface 11 for each detection unit 12. At that time, each detection unit 12 adjusts the overlapping area so as to suppress the variation in detection sensitivity. Therefore, the input device 1 can reduce the variation in detection sensitivity at each position (each contact point 22) of the contact operation surface 21. In addition, even when the operator moves his finger at a position distant from the contact operation surface 21 within a predetermined range, the input device 1 can also reduce the variation in detection sensitivity. Therefore, the input device 1 of the present embodiment can accurately detect an operation mode performed by the operator.

Further, in the input device 1 of the present embodiment, it is possible to adjust the detection sensitivity without adding components other than the electrostatic sensor 10 and the operation body 20. In other words, the input device 1 can suppress a variation in detection sensitivity without causing an increase in the number of components. Therefore, the input device 1 of the present embodiment can reduce the size and reduce the cost while improving detection accuracy.

Incidentally, as the width of the first electrode 13C having an elliptical shape as described above is narrower, differences in the areas of the respective first electrode units 13a in the extending direction become smaller. Therefore, it is difficult for the elliptical first electrodes 13C to have differences in the sizes of the overlapping areas of the respective detection units 12 in such a manner that variations in detection sensitivity are eliminated, as compared with the polygon having five or more sides or rhombus as described above. The same can be also said in a case where the second electrode 14 has an elliptical shape. Therefore, in this case, there is a possibility that countermeasures other than those in the electrostatic sensor 10 are required, and such countermeasures may include increasing the curvature of the curved line forming the curved surface of the contact operation surface 21 in the input device 1, as compared with the case of using the polygonal having five or more sides or rhomboid first electrodes 13A or the second electrode 14B, and reducing the difference in the distance Da between the detection surface 11 and the contact point 22 at each contact point 22, and the like. In other words, compared to the case of using the polygonal having five or more sides or rhomboid first electrode 13A or the second electrode 14B, there is a possibility that a degree of freedom in designing a shape of the contact operation surface 21 is lowered in the input device 1. Therefore, if in addition to the improvement in the detection accuracy, the degree of freedom in designing the shape of the contact operation surface 21 is required in the input device 1 of the present embodiment, it is preferable to form the first electrode 13 and the second electrode 14 in a polygonal having five or more sides or a rhombus shape rather than in an elliptical shape.

### Modification

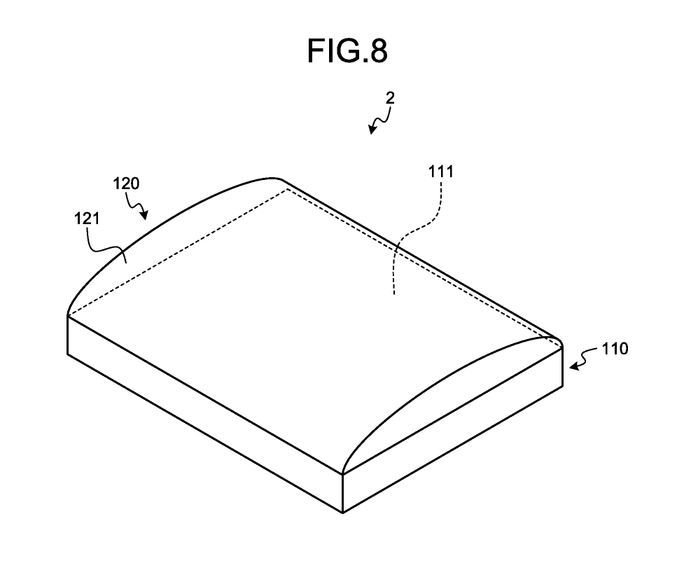

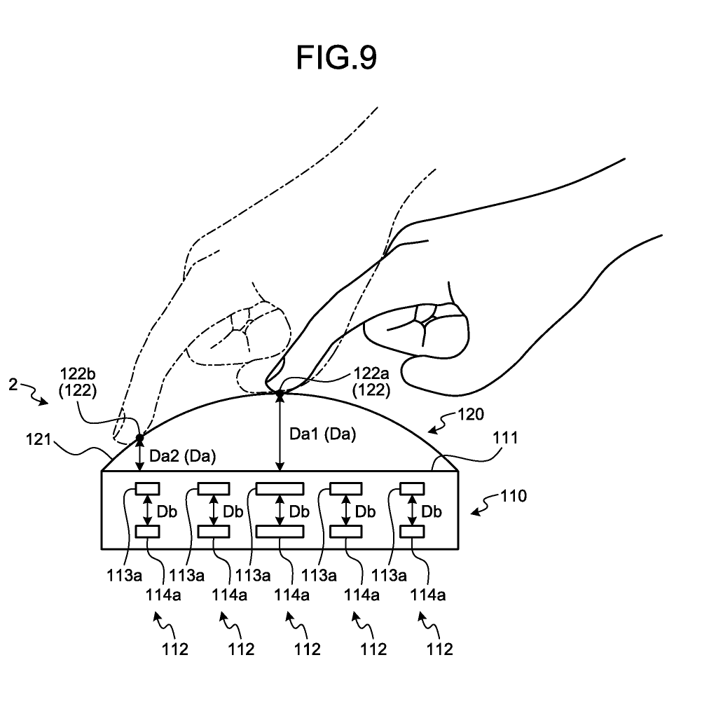

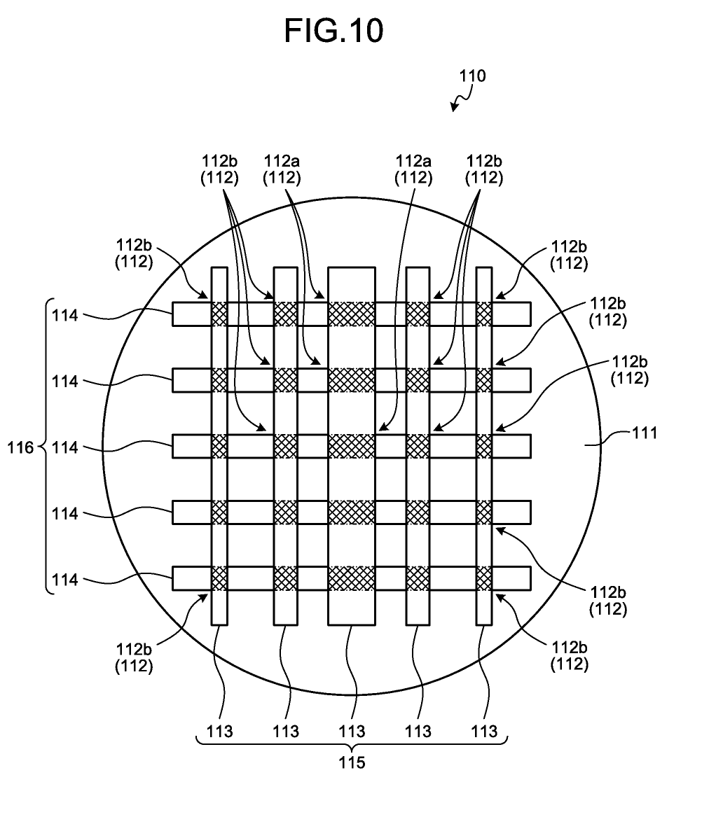

Reference numeral 2 in FIGS. 8 and 9 illustrates the input device of the present modification. The input device 2 includes an electrostatic sensor 110 and an operation body 120 in the same manner as the input device 1 of the above-described embodiment. The electrostatic sensor 110 includes a plurality of detection units 112 arranged on a two-dimensional plane serving as a detection surface 111 of an operation mode (cross-hatched portions in FIG. 10). The operation body 120 has a contact operation surface 121 to be contacted and operated by an operator (FIGS. 8 and 9).

Further, in the input device 2 of the present modification, a contact operation surface 121 is an assembly of a plurality of contact points 122 (FIG. 9) that the operator can touch with his finger, and all the contact points 122 are arranged with a distance Da from the detection surface 111 of the electrostatic sensor 110 in a direction perpendicular to the detection surface 111. Further, in the input device 2, the contact operation surface 121 is divided into at least two regions in which the distance Da between the detection surface 111 and the contact point 122 becomes non-uniform. In the present modification, an arcuate curved surface along one direction is formed as the contact operation surface 121 (FIG. 8). All curved lines forming curved surface of the contact operation surface 121 may have the same curvature, and the curved surface may be formed by curved lines having a plurality of different curvatures. Here, the contact operation surface 121 is formed with curved surfaces all having the same curvature.

The detection surface 111 of the electrostatic sensor 110 of the present modification is formed in a rectangular shape.

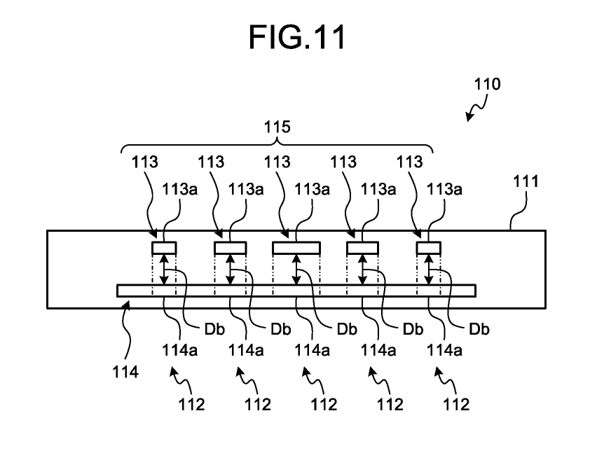

Like the detection unit 12 of the embodiment, the detection unit 112 of the electrostatic sensor 110 includes one first electrode unit 113a and one second electrode unit 114a (FIG. 11). The first electrode unit 113a and the second electrode unit 114a are disposed to have an inter-electrode distance Db therebetween in a direction perpendicular to the detection surface 111 so as to generate an electrostatic capacitance. In addition, the first electrode unit 113a and the second electrode unit 114a change an electrostatic capacitance according to the contact operation by the operator on the contact operation surface 121 or when the operator brings his finger close to the contact operation surface 121. Here, a first electrode unit 113a is arranged closer to the contact operation surface 121 than a second electrode unit 114a is, and the first electrode unit 113a functions as a transmission electrode and the second electrode unit 114a functions as a reception electrode.

Also in the present modification, the electrostatic sensor 110 is configured such that the overlapping area (cross-hatched portions in FIG. 10) of the first electrode unit 113a and the second electrode unit 114a is reduced when viewed in the direction perpendicular to the detection surface 111, as the detection unit 112 is disposed at a position where the distance Da between the contact point 122 and the detection surface 111 decreases. For the detection unit 112 of the present modification, the overlapping area decreases, as the detection unit 112 is closer to the end portion of the curved line than the middle portion of the curved line forming the curved surface of the contact operation surface 121.

Specifically, the electrostatic sensor 110 includes a first electrode group 115 in which a plurality of first electrodes 113 having a plurality of first electrode units 113a are arranged, and a second electrode group 116 in which a plurality of second electrodes 114 having a plurality of second electrode units 114a are arranged (FIG. 10). In this electrostatic sensor 110, the first electrode group 115 is arranged closer to the contact operation surface 121 than the second electrode group 116 is. Further, in the electrostatic sensor 110, the first electrode 113 is used as a transmission electrode and the second electrode 114 is used as a reception electrode. The respective first electrodes 113 of the first electrode group 115 are arranged in the same manner as the respective first electrodes 13 of the first electrode group 15 of the embodiment. The respective second electrodes 114 of the second electrode group 116 are arranged in the same manner as the respective second electrodes 14 of the second electrode group 16 of the embodiment.

Here, in the electrostatic sensor 110, one of the first electrode 113 and the second electrode 114 extends along a dividing line connecting both ends of the curved line forming the curved surface of the contact operation surface 121, and the other of the first electrode 113 and the second electrode 114 extends in a direction perpendicular to the dividing line. Here, the first electrode 113 extends in the direction perpendicular to the dividing line, and the second electrode 114 extends along the dividing line.

In the electrostatic sensor 110, each of the first electrode 113 and the second electrode 114 is formed in a rectangular shape whose longitudinal direction is an extending direction of each of the first electrode 113 and the second electrode 114. Further, in the electrostatic sensor 110, the width of the electrode unit (first electrode unit 113a) decreases, as the electrode (first electrode 113) extending in the direction perpendicular to the dividing line is disposed at a position more distant from center of the detection surface 111.

In the electrostatic sensor 110 of the present modification, on the detection surface 111, the distance Da1 between the contact point 122a at the middle portion (center) of the curved line forming the curved surface of the contact operation surface 121 and the detection surface 111 is the widest, and the distance Da2 between the contact point 122b and the detection surface 111 decreases as it goes from the middle portion to the end portion of the curved line (FIG. 9). However, in this electrostatic sensor 110, the overlapping area of the detection unit 112b is smaller than that of the detection unit 112a disposed on the middle portion of the curved line, as the detection unit 112b is disposed at a position closer to the end side of the curved line. Therefore, although the shape of the contact operation surface 121 of the electrostatic sensor 110 is different, it is possible to obtain the same effect as that of the above-described embodiment.

Meanwhile, in the embodiment and the modifications described above, the contact operation surfaces 21 and 121 are formed in the nonplanar surface (curved surface). However, even if the contact operation surface is formed in a flat surface, if the contact operation surface is arranged to be inclined with respect to the detection surfaces 11 and 111, the input devices 1 and 2 may be configured based on the same idea as that in the embodiment and the modifications. In other words, when the contact operation surface is inclined with respect to the detection surface 11 or 111, it would be okay if the overlapping area of the first electrode unit 13a or 113a and the second electrode unit 14a or 114a when viewed in the direction perpendicular to the detection surface 11 or 111 decrease as the detection unit 12 or 112 is disposed in such a way that the distance Da with the contact point 22 or 122 on the detection surface 11 or 111 becomes narrower. Even in this case, the input devices 1 and 2 can obtain effects similar to those of the above-described embodiments and modifications.

An input device according to the present embodiments adjusts, for each detection unit, an overlapping area of a first electrode unit and a second electrode unit, which constitute the detection unit, according to a distance between the detection unit on the detection surface and the contact point in the direction perpendicular to the detection surface. At that time, each detection unit adjusts the overlapping area so as to suppress the variation in detection sensitivity. Therefore, the input device can reduce the variation in the detection sensitivity at each position (each contact point) on the contact operation surface. In addition, the input device can reduce variations in detection sensitivity even when an operator moves his finger at a position within a predetermined range of distance from the contact operation surface. Therefore, the input device according to the present embodiments can accurately detect an operation mode performed by the operator. Further, the input device according to the present embodiments can adjust the detection sensitivity without adding components other than the electrostatic sensor and the operation body. That is, this input device can suppress the variation in detection sensitivity without causing an increase in the number of components. Therefore, the input device according to the present embodiments can downsize a physique and reduce a cost while improving the detection accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input device comprising:
an electrostatic sensor having a plurality of detection units arranged on a two-dimensional plane serving as a detection surface of an operation mode; and
an operation body having a contact operation surface to be contact-operated by an operator, wherein
the contact operation surface is an assembly of a plurality of contact points that the operator can touch with his finger, all the contact points are arranged with a distance from the detection surface in a direction perpendicular to the detection surface, and the contact operation surface is divided into at least two regions where the distance between the detection surface and the contact point becomes nonuniform,
the detection unit includes one first electrode unit and one second electrode unit, the first and second electrode units being arranged in the direction perpendicular to the detection surface so as to have an inter-electrode distance therebetween to generate an electrostatic capacitance, and the first electrode unit and the second electrode unit varying the electrostatic capacitance in accordance with the contact operation by the operator on the contact operation surface or when the operator brings his finger close to the contact operation surface, and
in the electrostatic sensor, an overlapping area of the first electrode unit and the second electrode unit when viewed in the direction perpendicular to the detection surface decreases as the detection unit is disposed in such a way that a distance with the contact point on the detection surface becomes narrower in the direction perpendicular to the detection surface.

2. The input device according to claim 1, wherein
the electrostatic sensor includes a first electrode group and a second electrode group, the first electrode group having a plurality of first electrodes extending in the same direction along a first parallel plane with respect to the detection surface, the plurality of first electrodes being disposed in parallel while having a space therebetween in a direction perpendicular to an extending direction of the first electrodes, the second electrode group having a plurality of second electrodes extending in the same direction along a second parallel plane with respect to the detection surface, and the plurality of second electrodes being disposed in parallel while having a space therebetween in a direction perpendicular to an extending direction of the second electrodes,
the first electrode group and the second electrode group are disposed in the direction perpendicular to the detection surface while having the inter-electrode distance therebetween and in such a way that the first electrode and the second electrode intersect with each other when viewed in the direction perpendicular to the detection surface,
each of the first electrodes includes the first electrode unit intersecting with the second electrode unit in the direction perpendicular to the detection surface for each of the second electrodes, and
each of the second electrodes includes the second electrode unit intersecting with the first electrode unit in the direction perpendicular to the detection surface for each of the first electrodes.

3. The input device according to claim 1, wherein
the contact operation surface is formed to be a nonplanar surface.

4. The input device according to claim 2, wherein
the contact operation surface is formed to be a nonplanar surface.

5. The input device according to claim 1, wherein
when the contact operation surface is a spherical curved surface, the overlapping area decreases as the detection unit is disposed at a position more distant from a center on the detection surface.

6. The input device according to claim 2, wherein
when the contact operation surface is a spherical curved surface, the overlapping area decreases as the detection unit is disposed at a position more distant from a center on the detection surface.

7. The input device according to claim 1, wherein
when an arcuate curved surface along one direction is formed as the contact operation surface, the overlapping area decreases as the detection unit is disposed closer to an end portion of a curved line forming the curved surface than a middle portion of the curved line.

8. The input device according to claim 2, wherein
when an arcuate curved surface along one direction is formed as the contact operation surface, the overlapping area decreases as the detection unit is disposed closer to an end portion of a curved line forming the curved surface than a middle portion of the curved line.
